(19) United States
(12) Patent Application Publication
(10) Pub. No.: US 2009/0153077 A1
(43) Pub. Date: Jun. 18, 2009

(54) Illumination Unit and Fixing Bracket Thereof

(76) Inventor: Si Chung Noh, Gyeonggi-do (KR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/225,850

(22) PCT Filed: Mar. 27, 2007
(86) PCT No.: PCT/KR2007/001490

§ 371 Date: Sep. 25, 2008

(30) Foreign Application Priority Data
Mar. 27, 2006 (KR) 10-2006-0027493
Apr. 19, 2006 (KR) 10-2006-0035295

(51) Int. Cl. H05B 37/02

(52) U.S. Cl. 315/294

(57) ABSTRACT

The present invention disclosed herein is an illumination unit and a fixing bracket thereof. The illumination unit according to the present invention includes an illumination lamp and a fluorescent lighting fixture, which are combined in a body. The illumination unit comprises: the illumination lamp configured to include a sealed tube having a predetermined length and two auxiliary tubes, wherein the two auxiliary tubes are successively formed adjacent to both ends of the tubes, and include an electrode and a couple of connection pins, which are respectively formed inside and outside thereof; and the fluorescent lighting fixture configured to include a board of a predetermined configuration and a housing combined with the board by a combination means, wherein the auxiliary tubes are fixed at both ends of the board by a holder. The fluorescent lighting fixture includes a power input terminal, a connection terminal electrically connected to other fluorescent lighting fixture, a substrate electrically connected to the power connection terminal and the connection terminal, and a control unit configured on the substrate and having a stabilizer consisting of electronic components such as a resistance, condenser, and a transistor controlling on/off of the illumination lamp.

The invention relates to illumination units and fixing brackets thereof and more particularly, to an illumination unit and a fixing bracket preventing exposure of black status generated from ends of an illumination lamp as well as discontinuity of illumination lamps sequentially installed by easily connecting a plurality of fluorescent lighting fixtures where illumination lamps are installed.

In general, metal bases with a predetermined length are electrically connected to sockets of fluorescent lighting fixtures at one end or both ends of discharge lamps or illumination lamps such as fluorescent lamps or neon lights, which are turned on/off when power supply is applied.

These illumination lamps are combined with sockets mounted on both ends of the lighting fixtures. To satisfy continuous lighting, these lighting fixtures are successively connected. In this case, there occurs dark zone phenomenon due to metal bases and sockets of the lighting fixtures so that continuous lighting is not accomplished. In addition, such discontinuous lighting occurs when both ends of illumination lamps become dark. This phenomenon is known as black status (hereinafter, referred to as “black status”).

The following two reasons of this black status can be found. One is that Barium (Ba) coated with electrodes of illumination lamps for the purpose of easily discharging electrons is vaporized as illumination lamps are used for a long time, so that the ends of the illumination lamps become black. The other is that as filaments being electrodes are preheated, tungsten is oxidized to be adhered to inner sidewalls of illumination lamps.

In the event that a plurality of lighting fixtures are successively arranged in order to embody continuous lighting, there are inherent disadvantages, such as dark zone due to sockets of lighting fixtures and metal bases of illumination lamps. Additionally, lighting is not continuous owing to this dark zone in the vicinity of ends of illumination lamps by black status.

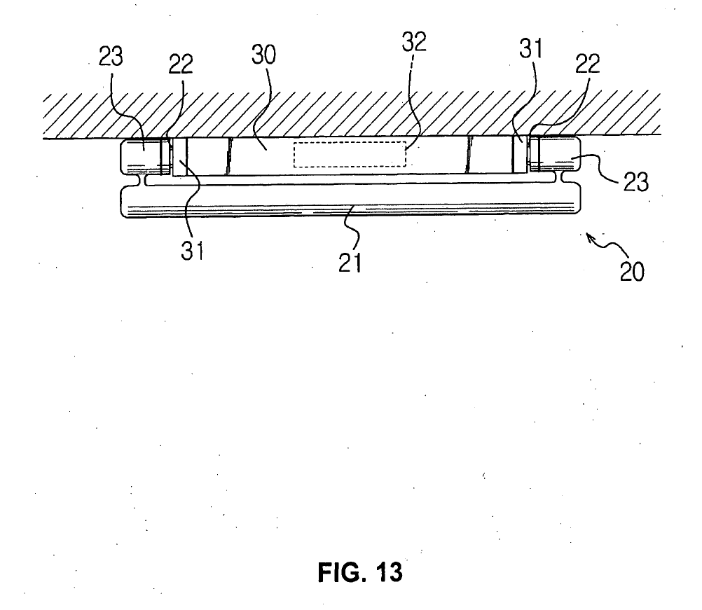

In order to overcome theses drawbacks, the present applicant has proposed fluorescent lamp, which is disclosed in Korean Patent No. 2005-51414. FIGS. 13 to 15 show the construction of a conventional fluorescent lamp of the above-mentioned patent.

As shown in FIGS. 13 to 15, the conventional fluorescent lamp comprises a tube-shaped body, auxiliary tubes extended to both ends of the body, and a connection terminal formed at inner ends of the auxiliary tubes.

In addition, the conventional fluorescent lamp has a lighting means that is located between the auxiliary tubes and performs a function for lighting. A lighting fixture with a fastener for fixing the connection terminal is further included at the both ends of the conventional fluorescent lamp. A vane for protecting the auxiliary tubes is extendedly formed at the lighting fixture.

However, in this case, there is a problem in that when fluorescent lamps or illumination lamps are changed, or defected lamps are again installed from the lighting fixtures, these lamps are broken down by user's carelessness to cause many accidents.

Moreover, conventional fluorescent lamps are closely arranged in a series, but such installation of the lighting fixtures causes inconvenience to users.

In other words, there is a disadvantage that users takes lighting fixtures and fixes several fastening means to ceiling in installing lighting fixtures using conventional fastening means.

It is therefore an object of the invention to provide an illumination unit capable of preventing discontinuous lighting due to black status and maintaining good appearance of the illumination unit by partially inserting an auxiliary tube into a housing and an inner board in an illumination lamp of double structure having a tube and the auxiliary tube.

It is therefore another object of the invention to provide an illumination unit capable of embodying continuous lighting in connecting lighting fixtures by inserting the illumination lamp of double structure having the tube and the auxiliary tube into the housing and the inner board in a body.

It is therefore still another object of the invention to provide an illumination unit and a fixing bracket for allowing the illumination unit to be easily installed and changed by the lighting fixture of the illumination lamp that can be easily removable via slid form or inserting form from a pre-installed fixing bracket or a setter.

It is therefore yet another object of the invention to provide an illumination unit and a fixing bracket capable of preventing damage of the illumination lamp and preventing accident by easily changing the illumination unit.

It is therefore further another object of the invention to provide an illumination unit capable of electrically and directly connecting power from a power connection terminal to a connection terminal by independently connecting the power connecting terminal and the connecting terminal via wires as well as simplifying interconnection by allowing plural illumination units to be electrically connected through a connection cable for connecting the power connection terminal and the connection terminal.

Embodiments of the present invention provide an illumination unit including an illumination lamp and a fluorescent lighting fixture, which are combined in a body. The illumination unit comprising: the illumination lamp configured to include a sealed tube having a predetermined length and two auxiliary tubes, wherein the two auxiliary tubes are successively formed adjacent to both ends of the tubes, and includes an electrode and a couple of connection pins, which are respectively formed inside and outside thereof; and the fluorescent lighting fixture configured to include a board of a predetermined configuration and a housing combined with the board by a combination means and where the auxiliary tubes are fixed at both ends of the board by a holder, wherein the fluorescent lighting fixture includes a power input terminal, a connection terminal electrically connected to other fluorescent lighting fixture, a substrate electrically connected to the power connection terminal and the connection terminal, and a control unit on the substrate and having a stabilizer consist of electronic components such as a resistance, condenser, and a transistor controlling on/off of the illumination lamp.

In some embodiments, the board has an opening to be combined with a top portion of the housing and a fastening jaw at both sides of the board in a length direction so that the board is removable with a setter fixed to a ceiling, a wall, or a floor of a space.

In other embodiments, the board may easily emit heat generated from the stabilizer, the control unit, and the auxiliary tube to the outside by forming a plurality of heatproof holes at both sides of the board.

In further embodiments, an inserting groove is formed at one end of the board, and a combination pin is formed at the other end of the board so that the illumination unit is variously mounted by inserting the combination pin into the inserting groove of the plurality of illumination units.

In yet further embodiments, the housing comprises: a cover whose top portion is opened in a length direction so as to insert the auxiliary tube into both ends of the cover; and a holder mounted on both ends of the cover and having a storing part therein, wherein a penetrating hole and an inserting hole are formed by opening top portions of sidewalls located inside and outside of the cover, and wherein the auxiliary tube is partially inserted into the penetrating hole, and simultaneously the connection pin of the auxiliary tube is penetrated into the inserting hole.

In other embodiments, a protecting case with an opened top portion is slid or inserted into both sides of the board so as to protect the illumination lamp mounted on the housing from the outside.

In further embodiments, a slide jaw and a supporting jaw are mounted up and down in both lowered sidewalls of the setter in order that the setter is combined with the fastening jaw formed at both sides of the board, and wherein a top portion of the board and the fastening jaw are slid to be combined between the slide jaw and the supporting jaw, and wherein the setter is fixed using a fastening means by penetrating a fixing hole into a top portion of the setter.

In yet further embodiments, the illumination unit may further comprise a connection cable.

In other embodiments, the connection cable comprises: a plug-type connection terminal having an input pin inserted into the power input terminal of the board to provide power to the substrate of the control unit; socket-type connection terminal having an output pin inserted into the connection terminal to transmit electricity; and a connection wire for electrically connecting the plug-type connection terminal and the socket-type connection terminal.

In further embodiments, the combination means comprises: a projection pin formed on the cover of the housing; a mounting pin protruded from the board; and a combination hole respectively corresponding to the projection pin and the mounting pin, wherein the board and the housing are combined using a fixing means in a body.

In yet further embodiments, wires are independently connected to the power connection terminal and the connection terminal of the board to electrically and directly connect power from the power connection terminal to the connection terminal.

In other embodiments, the fixing bracket comprises: the slide jaw formed in both lowered sidewalls of the fixing bracket to be fastened with the fastening jaw formed at both sides of the board so as to be slid on the board; a closing jaw closely contact with the top portion of the board to be combined with the board; a fixing hole formed a part of the top portion of the fixing bracket; and a combination jaw formed inwardly from an opened top fixing bracket, wherein a guide jaw is formed at both ends of the power input terminal and the connection terminal of the connection cable, and wherein the fastening jaw of the board is combined and separated with/from the guide jaw to be combined with the combination jaw and the slide jaw of the fixing bracket.

In further embodiments, the illumination unit may further comprise opened grooves. The opened grooves are formed at both sides of the fixing bracket for preventing expansion and shrinking of the fixing bracket from heat, wherein the opened grooves are separated as much as a predetermined distance to be inserted into the board via the slide jaw of the fixing bracket.

The accompanying drawings are included to provide a further understanding of the invention, and are incorporated in and constitute a part of this specification. The drawings illustrate example embodiments of the present invention and, together with the description, serve to explain principles of the present invention. In the drawings:

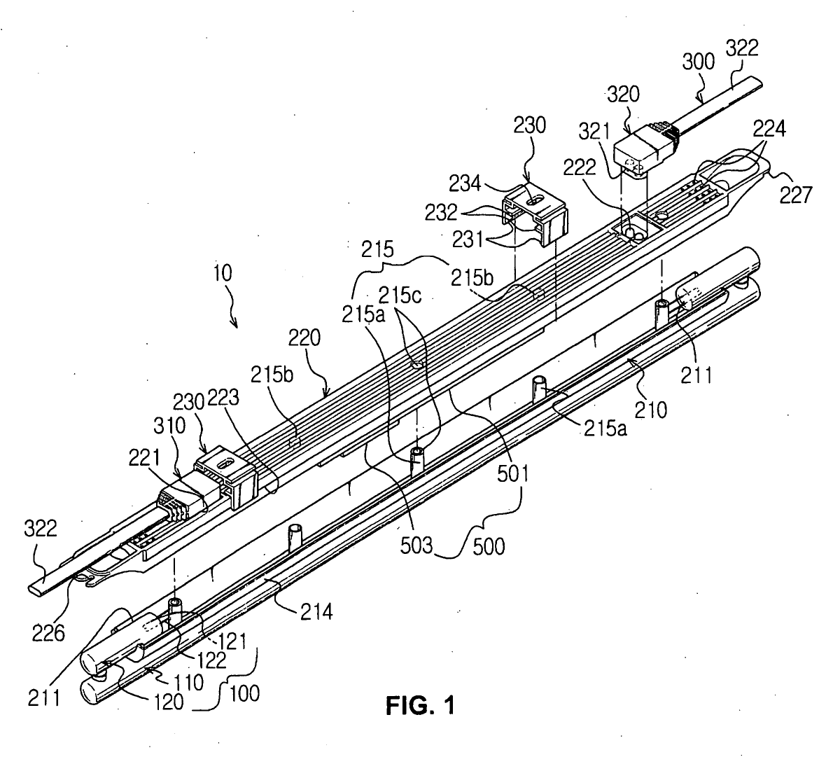

FIG. 1 is a perspective view showing an illumination unit and a connection cable in accordance with an embodiment of the present invention disassembled in detail;

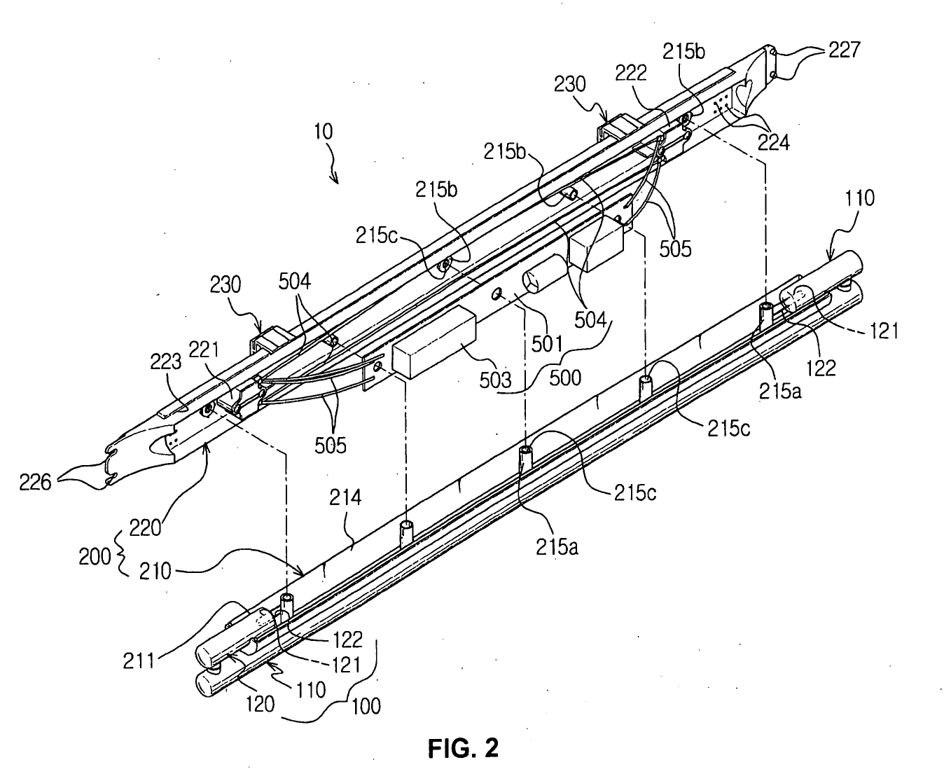

FIG. 2 is a perspective view showing a board of an illumination unit in accordance with an embodiment of the present invention disassembled in detail;

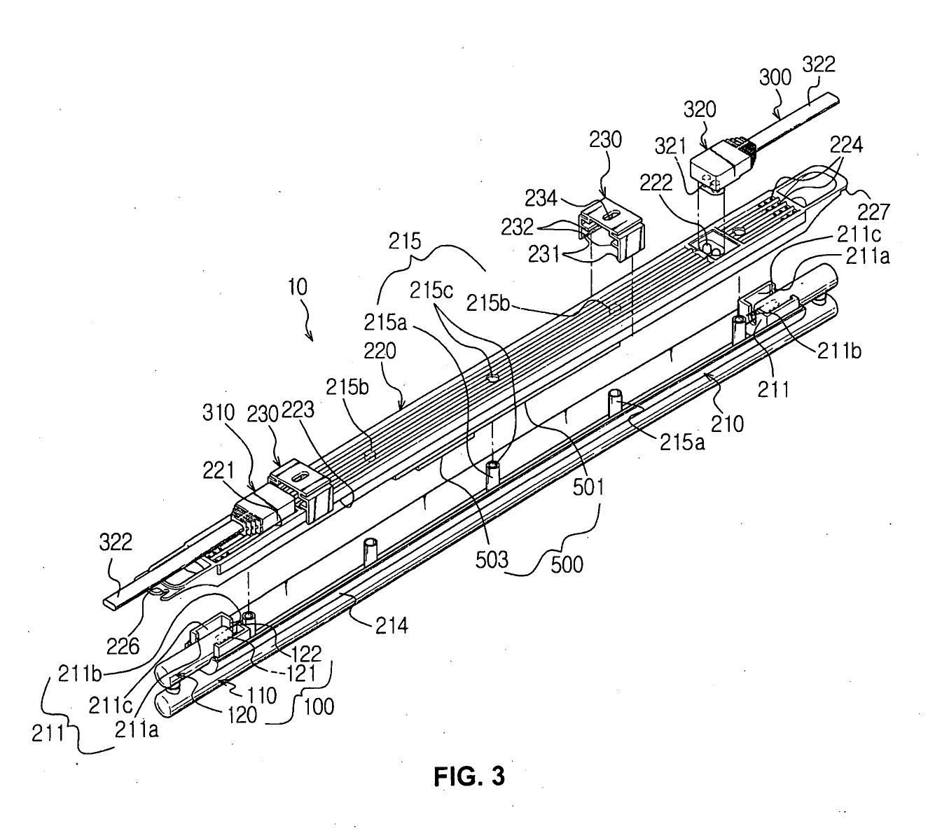

FIG. 3 is a perspective view showing an illumination unit and a connection cable in accordance with another embodiment of the present invention disassembled in detail;

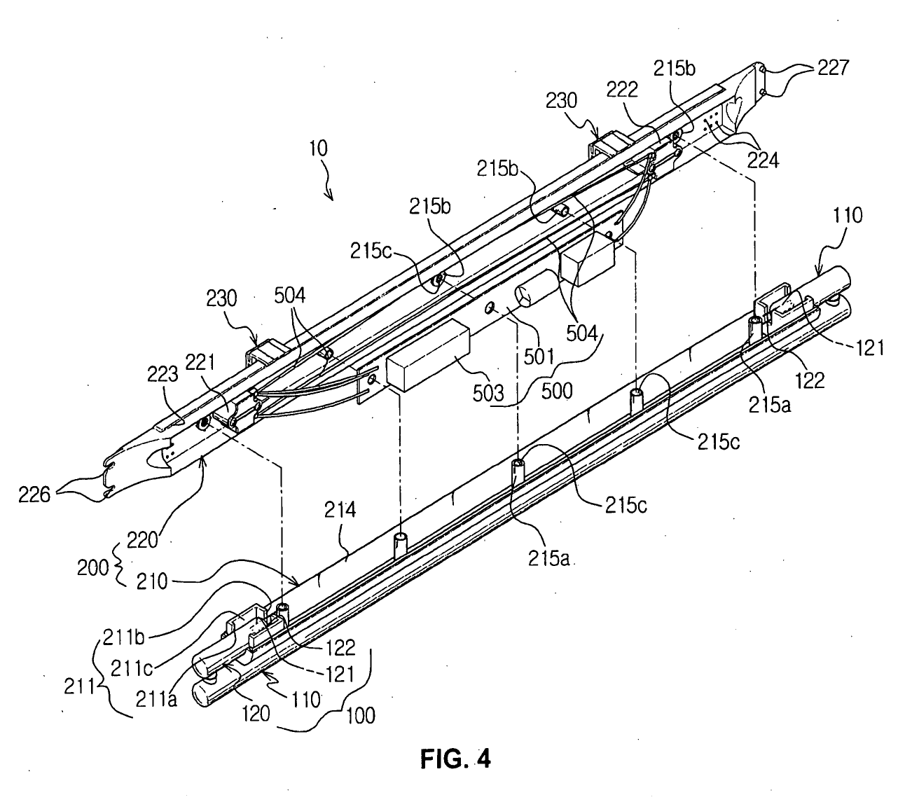

FIG. 4 is a perspective view showing a board of an illumination unit in accordance with another embodiment of the present invention disassembled in detail;

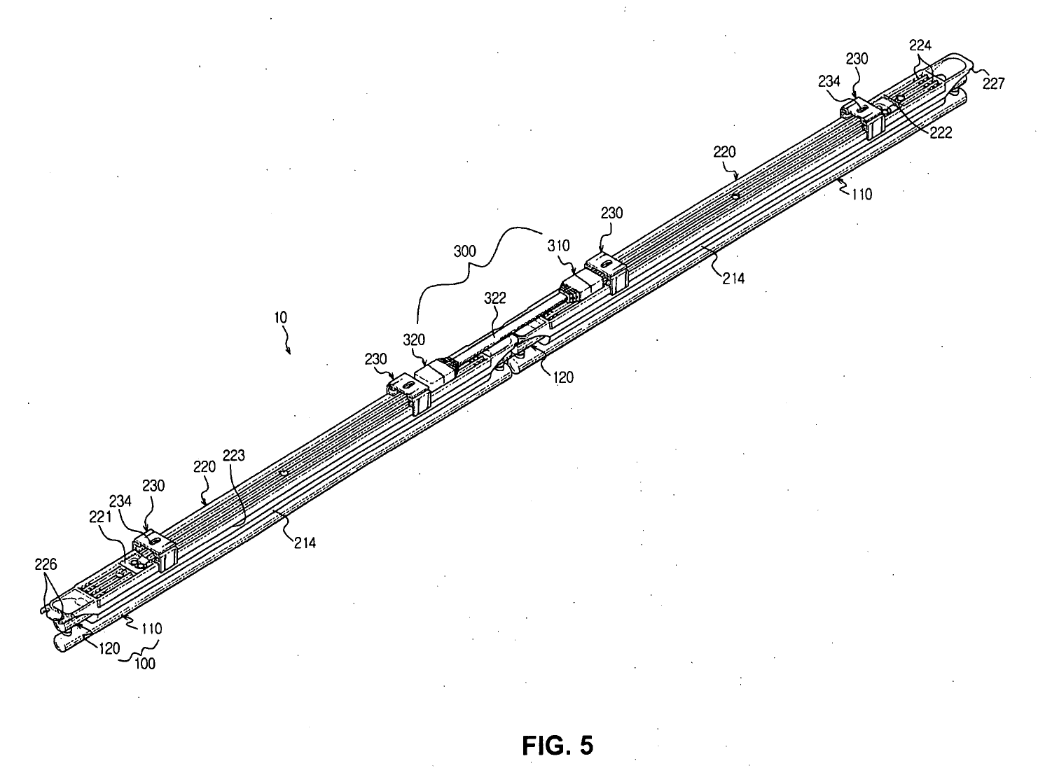

FIG. 5 is a perspective view showing illumination units connected in a series in accordance with an embodiment of the present invention;

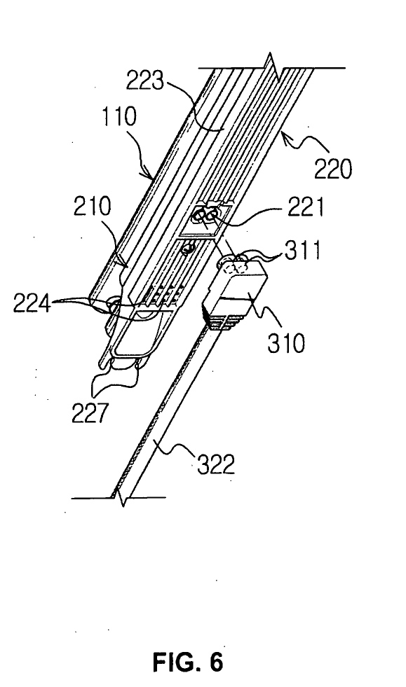

FIG. 6 is an exploded perspective view showing an illumination unit in accordance with an embodiment of the present invention;

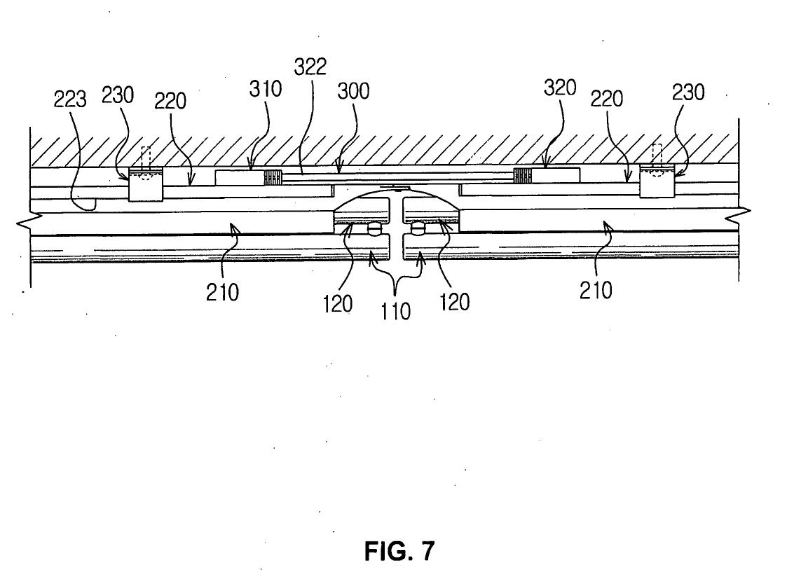

FIG. 7 is a lateral view showing illumination units connected in a series in accordance with an embodiment of the present invention;

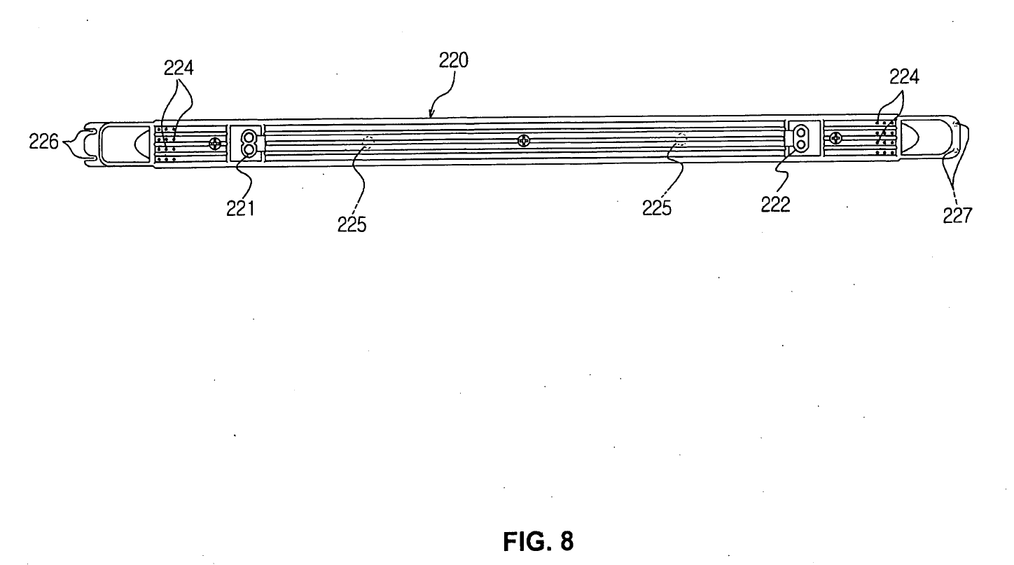

FIG. 8 is a plane view showing an illumination unit in accordance with an embodiment of the present invention;

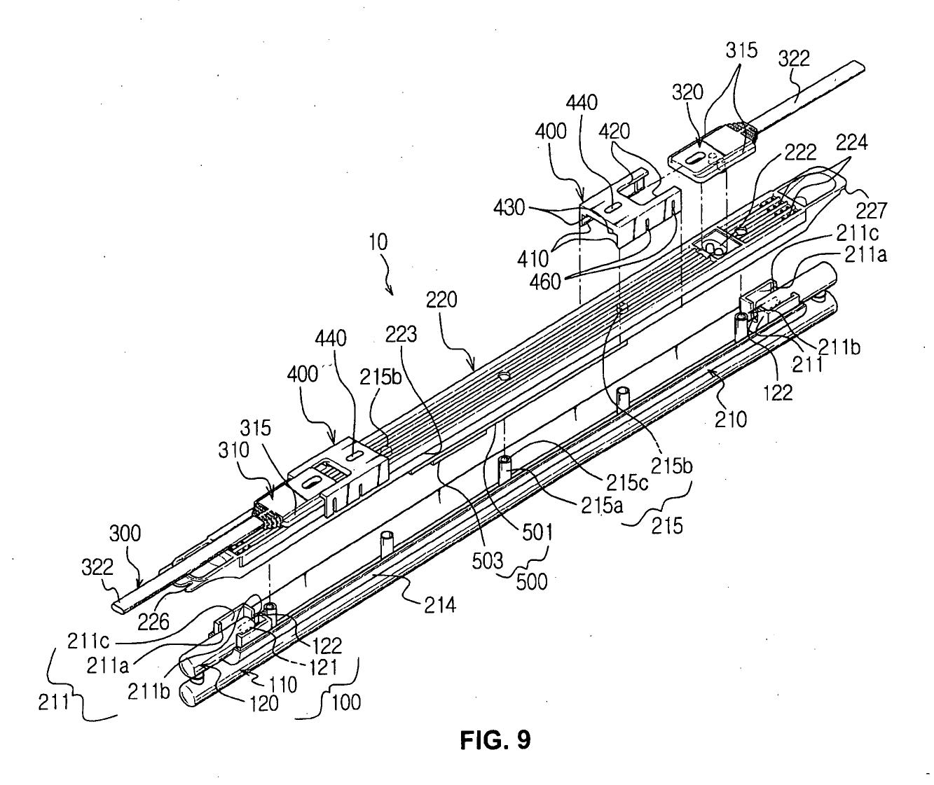

FIG. 9 is a perspective view showing a fixing bracket of an illumination unit in accordance with still another embodiment of the present invention partially disassembled;

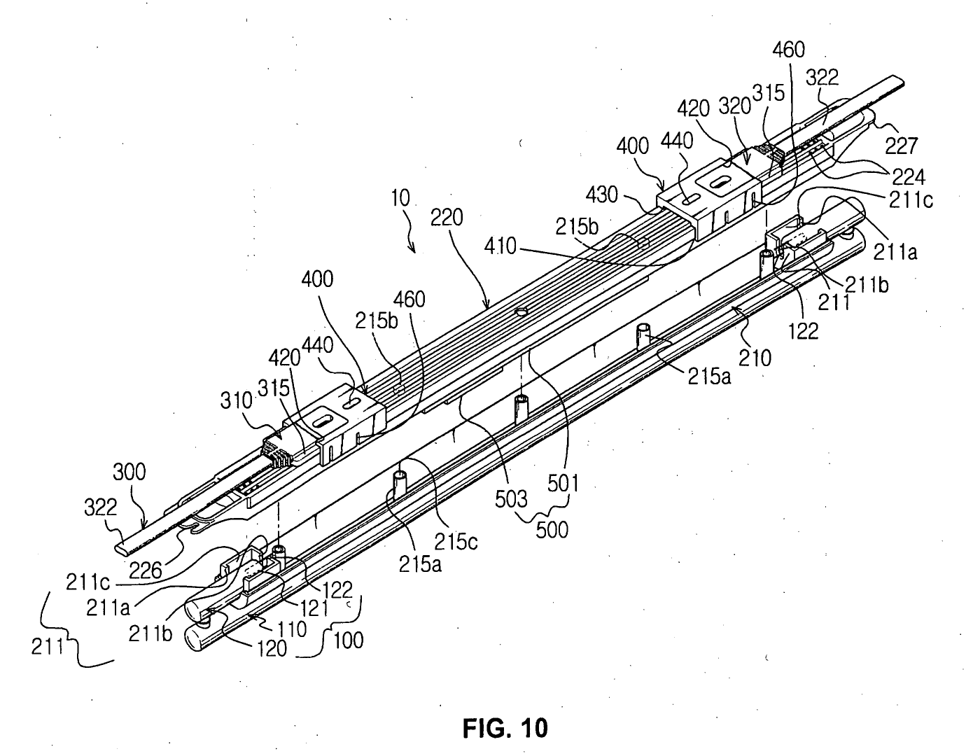

FIG. 10 shows the combination of a fixing bracket of an illumination unit in accordance with still another embodiment of the present invention;

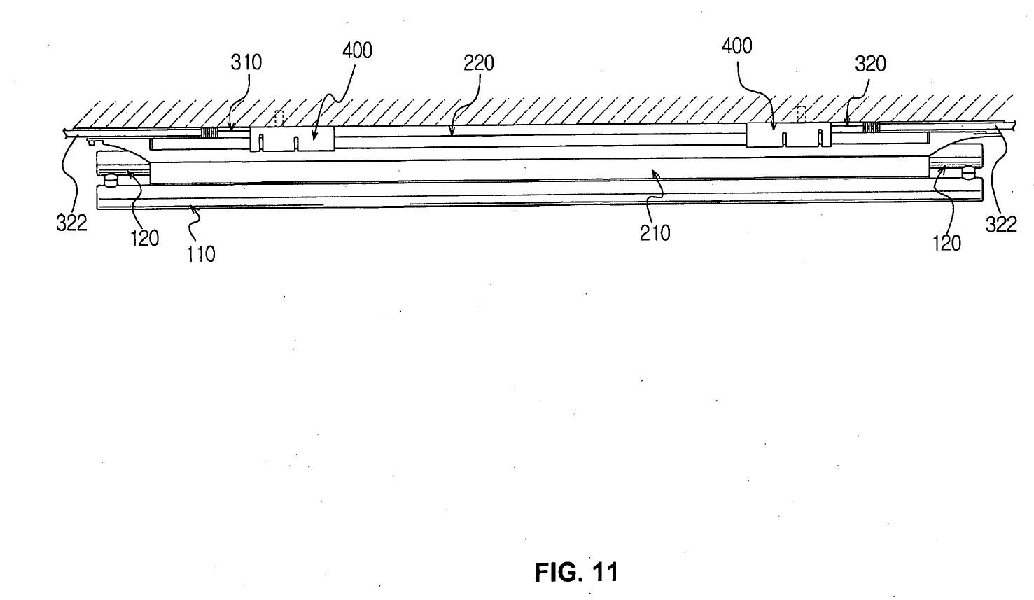

FIG. 11 is a lateral view showing that a fixing bracket of an illumination unit is installed in accordance with still another embodiment of the present invention;

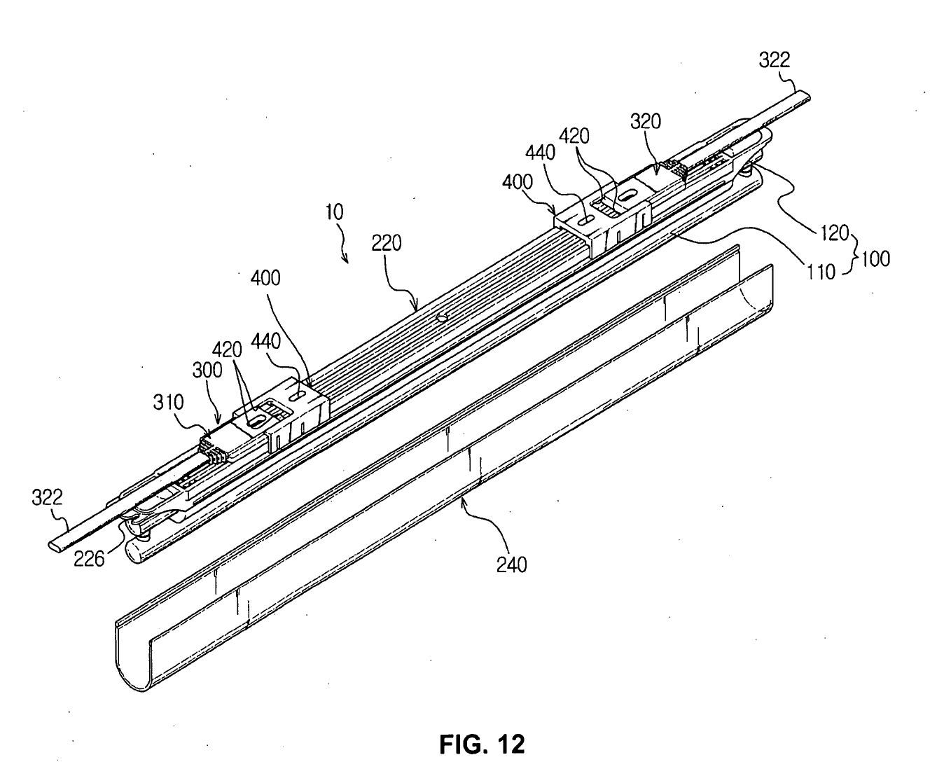

FIG. 12 is a perspective view showing that a protecting case is installed on a fixing bracket of an illumination unit in accordance with still another embodiment of the present invention disassembled in detail;

FIG. 13 is a front view showing a conventional fluorescent lamp in accordance with a prior art;

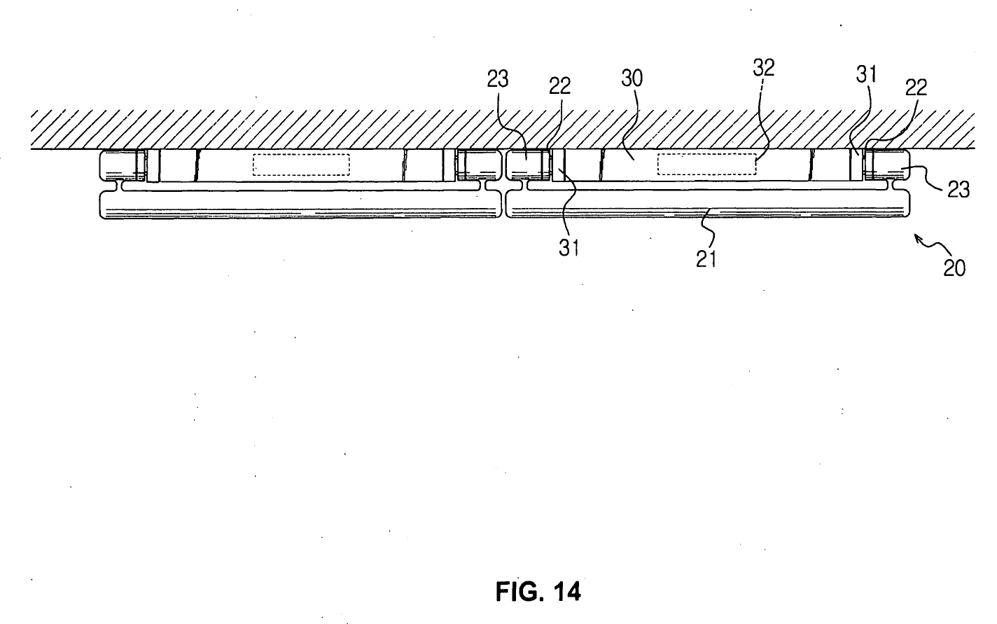

FIG. 14 is a front view showing that conventional fluorescent lamps are connected in a series in accordance with a prior art; and

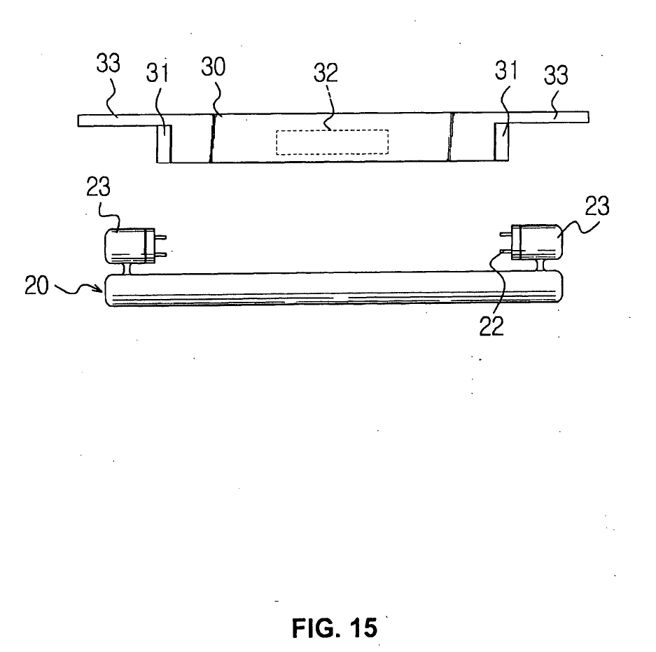

FIG. 15 is a front view showing conventional fluorescent lamps are separated in accordance with another embodiment of a prior art.

### EXAMPLES

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element such as a layer, region or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

Embodiments of the invention are described herein with reference to cross-section illustrations that are schematic illustrations of idealized embodiments (and intermediate structures) of the invention. The thickness of layers and regions in the drawings may be exaggerated for clarity. Additionally, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As shown in FIGS. 1 to 6, an illumination unit 10 of the present invention comprises an illumination lamp 100, a housing 210, a lighting fixture 200, a stabilizer 503, and a control unit 500. The illumination lamp 100 consists of a tube 110 containing luminous gases therein and auxiliary tubes 120 formed at both ends of the tube 110 to be one body. The housing 210 has a holder 211 in which the auxiliary tubes 120 are partially disposed. The lighting fixture 200 is formed by connecting the board 220 including a power connection terminal 221 and the connection terminal 222 to the housing 210. The stabilizer 503 performs a function to turn on/off the illumination lamp 100. The control unit 500 includes a substrate 501 having several electronic equipments.

As will be explained in more detail below, the illumination lamp 100 has a dual structure and is connected to the tube 110 in which luminous gases are contained. In addition, the illumination lamp 100 comprises an electrode 121 and a connection pin 122. The electrode 121 is formed in a couple of the auxiliary tubes 120, which are bent at both ends of the tube 110 to be formed in a body. The connection pin 122 provides power to the external position corresponding to the electrode 121. (See FIGS. 1 and 2)

In this case, the auxiliary tubes 120 which are bent in the shape of the letter C are formed at the both ends of the tube 110. Preferably, fluorescent substances are coated on inner sidewalls of the tube 110 and the auxiliary tubes 120.

In the present embodiments, the illumination lamp 100 is described in the example of fluorescent lamp or neon lamp, but it should be appreciated that the illumination lamp is not limited to the disclosed examples. It should be noted that illumination lamps such as discharge lamps turned on/ff by power are applicable to the present invention.

The illumination lamp 100 and a lighting fixture 200 are formed in a body. The lighting fixture 200 is constructed with the housing 210 and a board 220.

Hereinafter, the construction of the lighting fixture 200 will be described in more detail.

The housing 210 includes a cover 214 and a holder 211. The cover 214 has a top portion that is opened in the length direction so as to partially insert the auxiliary tubes 120 into both ends of the housing 210. The holder 211 is formed by opening both ends of the cover 214.

Then, the auxiliary tubes 120 are partially inserted into the holder 211 of the housing 210. Even though there occurs black status by using the illumination lamp 100 for a long time, black status neighboring the electrode 121 of the auxiliary tubes 120 is not exposed by the holder 211. Thus, it is possible that continuous lighting can be accomplished when plural illumination units 10 are connected with each other.

Another embodiment of the holder 211 capable of improving the bonding force of the housing 210 and the auxiliary tubes 210 is described as followings.

The holder 211 is formed at the both ends of the cover 214 and includes a storing part 211c, a penetrating hole 211a, and an inserting hole 211b. The penetrating hole 211a and the inserting hole 211b are formed by opening top portions of sidewalls located inside and outside of the cover 214. The auxiliary tube 120 is partially inserted into the penetrating hole 211a, and simultaneously the connection pin 122 of the auxiliary tube 120 is penetrated into the inserting hole 211b.

Accordingly, the auxiliary tube 120 of the illumination lamp 100 is inserted into the penetrating hole 211a and the inserting hole 211b of the holder 211 so that the auxiliary tube 120 is motionlessly and stably combined with the housing 210.

Moreover, the board 220 is opened to be combined with a top portion of the housing 210. The control unit 500 embedding electronic equipments, for example stabilizer, is installed in the board 220. Power supplied from the power input terminal 221 is directly connected to the connection terminal 222 by wires and accordingly, power is supplied to plural illumination unit through a connection cable 300. At the same time, a substrate 501 is electrically connected to the power input terminal and the connection terminal 222 through a sub-wire in the control unit 500, and the control unit 500 controls on/off of the illumination lamp 100 through a stabilizer 503 embedded on thereon. (See FIGS. 1 to 4)

In this regard, the control unit 500 prevents overflowing by the stabilizer 503. In addition, intensity of illumination is controlled via phase control mode or PWM mode through the substrate 501 embedding various electronic equipments in order to prevent increment of current.

Also, owing to the connection cable 300, power supply is independently provided to the illumination lamp 100 connected in a series. In this case, the connection cable 300 is successively installed to the power input terminal 221 and the connection terminal 222, which are capable of directly transmitting electricity by wires. As a result, even if one of plural illumination units 10 is damaged, it is possible to continuously provide power supply to the rest of the plural illumination units 10 via the wires 504.

A plurality of heatproof holes 224 are penetrated into the both ends of the board 220, thereby easily discharging heat generated from the stabilizer 503, the control unit 500, and the auxiliary tube 120 to the outside.

An inserting groove 226 is formed at one end of the board 220, and a combination pin 227 is formed at the other end of the board 220. Therefore, the illumination unit 10 is mounted in various angles such as in a series, perpendicularly, or the like by inserting the combination pin 227 into the inserting groove 226 of the plurality of illumination units 10.

A mounting pin 215b is protruded from the board 220 so as to combine the housing 210 and the board 220 in a body by a connection means 215. A projection pin 215a of the cover 214 corresponds to the mounting pin 215b. The mounting pin 215b and the projection pin 215a are connected by the combination hole 215c. Then, the board 220 and the housing 210 are combined by a fixing means such as screws.

Furthermore, as shown in FIG. 10, a protecting case 240 with an opened top portion is formed for the purpose of protecting the illumination lamp 100 of the housing 210. An opened inner top surface of the protecting case having elasticity is slid or inserted into both sides of the board 220.

Particularly, the protecting case 240 is made of transparent or semitransparent material. Additionally, the protecting case 240 may be coated with various colors by users' requirements.

Referring to FIGS. 1 to 4, the connection cable 300 is respectively connected to the power input terminal 221 and the connection terminal 222 of the board 220, thereby electrically connecting the plurality of illumination units 10, which are connected in a series. The connection cable comprises: a plug-type connection terminal 310 having an input pin 311 inserted into the power input terminal 221 of the board to provide power to the substrate 501 of the control unit 500; a socket-type connection terminal 320 having an output pin 321 inserted into the connection terminal 222 to transmit electricity; and a connection wire 322 for electrically connecting the plug-type connection terminal 310 and the socket-type connection terminal 320.

The construction of a setter 230 according to the illumination unit is described hereinafter referring to FIG. 1 or 3. In this regard, a setter is a fastening means on a ceiling, a wall or a flat floor etc for an illumination unit.

The a slide jaw 231 and a supporting jaw 232 are mounted up and down in both lowered sidewalls of the setter 230 in order that the setter 230 is combined with the fastening jaw 223 formed at both sides of the board 220. The top portion of the board 220 and the fastening jaw 223 are slid to be combined between the slide jaw 231 and the supporting jaw 232. The setter 230 is fixed using a fastening means by penetrating a fixing hole 234 into a top portion of the setter 230.

Namely, the setter 230 is fixed by inserting fastening means (e.g., wood screw) into the fixing hole 234 on ceiling, flat floor, or walls etc. Then, the setter 230 is slid to the fastening jaw 223 along the slide jaw 231 thereof and sidewalls of the supporting jaw 232. Or, the setter 230 is combined by pressing the board 220 to the space between a couple of slide jaws 231.

At this time, before fixing the lighting fixture 200 on the setter, the plug-type connection terminal 310 receiving power from the outside of the connection cable 300 is connected to the one end of the power input terminal 221 of the board 220. The reason for this is to apply power to the lighting fixture 206. The other end of the power input terminal 221 of the board 220 is connected to the socket-type connection terminal 320 of the connection cable 300. Accordingly, power supplied from the outside is provided to another lighting fixture 200.

After that, continuous lighting is embodied by adjacently installing a plurality of illumination units 10 in the setters 230 in a series. At this time, a board 220 is easily combined and separated with/from the setter 230 by pressing or pulling the board 220 respectively to/from the slide jaw 231 of the setter 230 due to the elasticity of the slid jaw 231.

Referring to FIGS. 7 to 9, another fixing bracket for fixing the illumination unit 10 is described as another embodiment of the present invention. The fixing bracket 400 comprises: the slide jaw 410 formed in both lowered sidewalls of the bracket 400 to be fastened with the fastening jaw 223 formed at both sides of the board 220 so as to be slid on the board 220; a closing jaw 430 closely contact with the top portion of the board 220 to be combined with the board 220; a fixing hole 440 formed a part of the top portion of the fixing bracket 400; and a combination jaw 420 formed inwardly from an opened top fixing bracket 400. In this case, a guide jaw 315 is formed at both ends of the power input terminal 221 and the connection terminal 222 of the connection cable 300, and the fastening jaw 223 of the board 220 is combined and separated with/from the guide jaw 315 to be combined with the combination jaw 420 and the slide jaw 410 of the fixing bracket 400. (See FIGS. 7 to 9)

Opened grooves 460 are formed at both sides of the fixing bracket 400 for preventing expansion and shrinking of the bracket from heat. The opened grooves 460 are separated as much as a predetermined distance to be inserted into the board 220 via the slide jaw 410 of the fixing bracket 400.

The above-mentioned illumination unit 10 is combined as following steps.

The plug-type connection terminal 310 and the socket-type connection terminal 320 of the connection cable 300 are combined in the opened combination jaw 232 of a couple of the fixing brackets 400. Then, the illumination unit 10 is fixed at the fixing bracket 400 and the fixing hole 440 by means of fastening means.

The fastening jaw 223 of the board 220 is elastically inserted into the slide jaw 410 by pressing the board 220 to the space between the slide jaws 410 of the fixing bracket 400. At the same time, the plug-type connection terminal 310 and the socket-type connection terminal 320 of the connection cable 300 are electrically connected, thereby fixing the illumination unit 10 to ceiling, flat floor, or walls etc.

Accordingly, the illumination unit 10 is easily installed or removed by means of the setter 230 and the fixing bracket 400.

The illumination unit 10 according to the present invention can be installed without space limitation. In addition, it is possible to simplify interconnection because plural illumination units 10 are electrically connected by the connection cable 300.

As previously mentioned, an illumination unit according to the present invention is capable of preventing discontinuous lighting due to black status and maintaining good appearance of the illumination unit by partially inserting an auxiliary tube into a housing and an inner board in an illumination lamp of double structure having a tube and the auxiliary tube.

Additionally, an illumination unit is capable of electrically and directly connecting power from a power connection terminal to a connection terminal by independently connecting the power connecting terminal and the connecting terminal via wires as well as simplifying interconnection by allowing plural illumination units to be electrically connected through a connection cable for connecting the power connection terminal and the connection terminal.

Furthermore, an illumination unit is capable of embodying continuous lighting in connecting lighting fixtures by inserting the illumination lamp of double structure having the tube and the auxiliary tube into the housing and the inner board in a body. A fixing bracket according to the present invention allows the illumination unit to be easily installed and changed by the lighting fixture of the illumination lamp that can be easily removable via slid form or inserting form from a pre-installed setter or the fixing bracket.

Additionally, the setter or the fixing bracket is capable of preventing damage of the illumination lamp and preventing accident by easily changing the illumination unit.

In accordance with the present invention, power supply is independently provided to plural illumination units by wires. Power supply is additionally provided to the control unit by sub-wires. Resultantly, irrespective of the damage of one illumination unit among plural illumination units, it is possible to stably and continuously provide power supply to the rest of illumination units.

Although the present invention has been described in connection with the embodiment of the present invention illustrated in the accompanying drawings, it is not limited thereto. It will be apparent to those skilled in the art that various substitution, modifications and changes may be thereto without departing from the scope and spirit of the invention.

1. An illumination unit including an illumination lamp and a fluorescent lighting fixture, which are combined in a body, the illumination unit comprising:
the illumination lamp configured to include a sealed tube having a predetermined length and two auxiliary tubes, wherein the two auxiliary tubes are successively formed adjacent to both ends of the tubes, and include an electrode and a couple of connection pins, which are respectively formed inside and outside thereof; and
the fluorescent lighting fixture configured to include a board of a predetermined configuration and a housing combined with the board by a combination means, wherein the auxiliary tubes are fixed at both ends of the board by a holder,
wherein the fluorescent lighting fixture includes a power input terminal, a connection terminal electrically connected to other fluorescent lighting fixture, a substrate electrically connected to the power connection terminal and the connection terminal, and a control unit on the substrate and having a stabilizer consisting of electronic components such as a resistance, condenser, and a transistor controlling on/off of the illumination lamp.

2. The illumination unit as set forth in claim 1, wherein the board has an opening to be combined with a top portion of the housing and a fastening jaw at both sides of the board in a length direction so that the board is removable with a setter fixed to a ceiling, a wall, or a floor of a space.

3. The illumination unit as set forth in claim 1, wherein the board easily emits heat generated from the stabilizer, the control unit, and the auxiliary tube to the outside by forming a plurality of heatproof holes at both sides of the board.

4. The illumination unit as set forth in claim 1, wherein an inserting groove is formed at one end of the board, and a combination pin is formed at the other end of the board so that the illumination unit is mounted in various angles such as in a series, perpendicularly, or the like by inserting the combination pin into the inserting groove of the plurality of illumination units.

5. The illumination unit as set forth in claim 1, wherein the housing comprises:
a cover whose top portion is opened in a length direction so as to insert the auxiliary tube into both ends of the cover; and
a holder mounted on both ends of the cover and having a storing part therein, wherein a penetrating hole and an inserting hole are formed by opening top portions of sidewalls located inside and outside of the cover, and
wherein the auxiliary tube is partially inserted into the penetrating hole, and simultaneously the connection pin of the auxiliary tube is penetrated into the inserting hole.

6. The illumination unit as set forth in claim 1, wherein a protecting case with an opened top portion is slid or inserted into both sides of the board so as to protect the illumination lamp mounted on the housing from the outside.

7. The illumination unit as set forth in claim 2, wherein a slide jaw and a supporting jaw are mounted up and down in both lowered sidewalls of the setter in order that the setter is combined with the fastening jaw formed at both sides of the board, and
wherein a top portion of the board and the fastening jaw are slid to be combined between the slide jaw and the supporting jaw, and
wherein the setter is fixed using a fastening means by penetrating a fixing hole into a top portion of the setter.

8. The illumination unit as set forth in claim 1, further comprising a connection cable, which embodies continuous lighting of the above-mentioned fluorescent lighting fixtures by electrical connection.

9. The illumination unit as set forth in claim 8, wherein the connection cable comprises:
a plug-type connection terminal having an input pin inserted into the power input terminal of the board to provide power to the substrate of the control unit;
a socket-type connection terminal having an output pin inserted into the connection terminal to transmit electricity; and
a connection wire for electrically connecting the plug-type connection terminal and the socket-type connection terminal.

10. The illumination unit as set forth in claim 1, wherein the combination means comprises:
a projection pin formed on the cover of the housing;
a mounting pin protruded from the board; and
a combination hole respectively corresponding to the projection pin and the mounting pin,
wherein the board and the housing are combined using a fixing means in a body.

11. The illumination unit as set forth in claim 1, wherein wires are independently connected to the power connection terminal and the connection terminal of the board to electrically and directly connect power from the power connection terminal to the connection terminal.

12. (canceled)

13. (canceled)
